(19) United States
(12) Patent Application Publication
(10) Pub. No.: US 2001/0042022 A1
(43) Pub. Date: Nov. 15, 2001

(54) Systems and methods for point of purchase product registration

(76) Inventors: Michael S. Kirkpatrick, Andover, MA (US); David L. Wagner, Boston, MA (US); Edward T. Stimpson, Wellesley, MA (US); Sean E. Brown, Boston, MA (US); Robert Glazer, Brookline, MA (US); Lisa Fitzgerald, Chapel Hill, NC (US); Daniel Oran, Cambridge, MA (US); Timothy Rowe, Cambridge, MA (US)

Correspondence Address: FOLEY, HOAG & ELIOT, LLP, PATENT GROUP, ONE POST OFFICE SQUARE, BOSTON, MA, 02109, US

(21) Appl. No.: 09/755,968

(22) Filed: Jan. 5, 2001

Related U.S. Application Data
(60) Provisional application No. 60/174,635, filed on Jan. 5, 2000.

(51) Int. Cl. G06F 17/60

(52) U.S. Cl. 705/26; 705/10

(57) ABSTRACT

The invention provides systems and methods that allow retail entities to let consumers register a product or warranty at the point of sale. More specifically, the systems and methods described herein allow a retailer to identify a point during a purchasing transaction wherein the consumer has completed a transaction. At that time, the retailer may presented to the consumer an interface that the consumer may easily complete to allow the consumer to participate in a product or warned she registration process. As such, the systems and methods described here and make the product registration process part of the purchase transaction and therefore make the product registration process seamless and more facile. Consequently it is understood that consumer participation within the product registration process increases.

### REFERENCE TO RELATED APPLICATIONS

This application claims priority to U.S. Ser. No. 60/174,635 filed Jan. 5, 2000, entitled Integrated Product Registration for Online Purchases, and naming Sean Brown, as inventor, the contents of which are hereby incorporated by reference.

### FIELD OF THE INVENTION

The systems and methods described herein relate to systems and methods for selling products and services, and more particularly to systems and methods for allowing a retailer to provide product registration at the point of sale.

### BACKGROUND OF THE INVENTION

Today, to be an effective competitor within the marketplace a company needs as much information about its customers as possible. Manufacturers that create products which are delivered through third party retail distribution channels face the problem that they are somewhat removed from their customer base. Thus, it is often difficult for manufacturers to actually interact, or collect information, about the customers who choose to buy their products. To address this issue, manufacturers commonly employ a product registration or warranty registration process that requests a customer to return a postcard to the manufacturer wherein the postcard contains information about that customer. With the returned postcard, the manufacturer then has some idea about the characteristics, demographics, or other features about the people buying their products.

Today, product registration is a broken process that provides little value to the manufacturers. For example, the registration process most commonly employed today involves providing within the packaging materials for a new product, a stamped addressed postcard that may be completed by the consumer and returned to the manufacturer through the mail. Although manufacturers strive to make this process as simple and painless as possible, response rates for returning such product and warranty registration cards are notably low. For the millions of products sold to consumers each year, fewer than 10 percent of product cards are ever returned.

In addition, manufacturers face cost issues and an inefficient process for evaluating the collected information. Processing costs for returned cards can be significant, and turnaround for compiled, usable data may take many months. Because of low response rates and incorrect information, traditional warranty/registration databases are of limited use for either market analysis or for communicating with customers.

Accordingly, manufacturers need a more efficient and cost-effective mechanism for having customers register their purchased products.

### SUMMARY OF THE INVENTION

Other objects of the invention will, in part, be obvious, and, in part, be shown from the following description of the systems and methods shown herein.

The systems and methods described herein provide for allowing retail entities to have consumers register a product or warranty with the associated manufacturer at the point of sale. More specifically, the systems and methods described herein allow a retailer to identify a point during a purchasing transaction wherein the consumer has completed a transaction. At that time, the retailer may present to the consumer a form that the consumer may easily complete to allow the consumer to participate in a product or warranty registration process. As such, the systems and methods described herein make the product registration process part of the purchase transaction and therefore make the product registration process seamless and more facile. Consequently it is understood that consumer participation within the product registration process increases.

More particularly, the systems and methods described herein include methods for product registration that comprise providing an online site for purchasing a product, providing an online registration form for registering the purchased product, identifying during the purchase transaction a completion point representative of when the purchase is complete, and displaying the online registration form subsequent to completion point for allowing a user to register a product, warranty, or other manufacturer provided incentive.

Registration can include the act of identifying to a manufacturer an interest in receiving information about a product, a product recall, a safety notice, opportunities to purchase an extended warranty or the expiration of an existing warranty, proof of purchase for insurance purposes, and online manuals. The opportunity to quickly and easily register products purchased at an online site allows for more facile management of assets. This is particularly important to small businesses as small businesses need to create inventories of the products and goods they own for insurance purposes.

The term registration or the term registration process will be understood to encompass the collection of data from consumers after the purchase of a product, service or other item from a business. These terms shall include, but not be limited to, registration processes wherein information is collected from a consumer about a purchased product or service and that information is delivered to the manufacturer or provider of that service for purposes of receiving warranty protection, extended warranty protection, product recall information, products safety information, to receive promotional information, or for any other purpose. Moreover, it will be understood that the terms registration and registration process do not require the delivery of consumer information to a manufacturer or other provider of good or services.

In certain optional practices the systems and methods described herein may be employed for providing an online site wherein the online site includes a server for purchasing products from a plurality of manufacturers, and wherein providing an online registration form includes associating the online registration form with one of the plurality of manufacturers.

The systems may also include a step of aggregating product registration data for determining the purchasing behavior of the consumer. Additionally, the practices will allow for employing product registration data for providing to a consumer information associated with a product that consumer has purchased. The information associated with a product may include information about a product recall, a warranty expiration, information about similar products, such as sales incentives on those similar products, and a survey form for collecting consumer satisfaction information.

In another practice, the methods described herein may include methods for allowing a retail site to provide online product registration, wherein in these methods comprise identifying products that are sold on the retail site and that may be registered online, providing for each product a registration requirement list representative of information to be collected from a consumer for registering the product with an associated manufacturer. The method may also include tracking purchases made by a consumer on the retail site that can be registered online, generating for the tracked purchases, a product registration page capable of prompting the consumer to enter information identified in the registration requirement list for each tracked purchase, and generating for each tracked purchase a product registration request having information capable of registering the product with the respective manufacturer.

In this practice, the methods may also include employing the registration information for each tracked purchase to generate a database representative of purchase activity of the consumer. Additionally the practices may include allowing a manufacturer to employ the registration information for a product manufactured by the manufacturer to deliver an e-mail advertisements for a product to a consumer. Optionally the e-mail advertisements may include a link to a retail site offering a product for sale and the e-mail advertisements may include a purchased incentive where a portion of the incentive is underwritten by the retail site and a portion of the incentive is underwritten by the manufacturer.

In a further aspect, the methods described herein may include a service for providing online retail sites with point of purchase product registration, comprising providing each online retail site with a link to a server for supporting online product registration, detecting activation of the link and delivering to the server information representative of products selected for registration, for each selected product, identifying a registration requirement list representative of information to be provided for registering the product with an associated manufacturer, generating a product registration page for prompting the consumer to enter information identified in each registration requirement list, and generating for the selected products a registration request having information capable of registering selected products with respective associated manufacturers.

In a further aspect, the invention may be understood as systems for allowing a retail site to offer a consumer the opportunity to register a product worksheet or other incentive at the point of purchase. These systems may include a server capable of receiving information from the retail site, and processing that information to determine the products purchased at that site for which the server has an entry in a database indicating that product registration information is available for that product. The server further includes a page generator for generating a web page that may be provided to the consumer for collecting from the consumer information that is to be provided to a manufacturer during the product or warranty registration process. Information returned from the consumer may be processed by the server to generate and e-mail registration notice that may be delivered to the manufacturer. The server may also receive confirmation from the manufacturer that the product has been registered, and confirmation of that registration may be forwarded from the server to the consumer.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts schematically one system according to the invention;

FIGS. 2-5 depict the operation of a system;

FIG. 6 depicts a user interface for allowing a consumer to select a mechanism to receive notifications;

### DESCRIPTION OF THE ILLUSTRATED EMBODIMENTS

To provide an overall understanding of the invention, certain illustrative embodiments will now be described. However, it will be understood by one of ordinary skill in the art that the systems and methods described herein can be adapted and modified for other suitable applications and that such other additions and modifications will not depart from the scope hereof. For example, it will be apparent to those of ordinary skill in the art that the systems and methods described herein may be employed for purchasing products from a conventional “brick and mortar” retailer. For example, the conventional retailer may be equipped with a cash register that includes an LCD display. Upon completion of a purchase transaction, the LCD display may present to a consumer a web page that queries the consumer whether the consumer wishes to register a product. If the consumer wishes to register a product, the consumer may enter the information, either by completing the web page by keyboard entry, touchpad control, beaming information from a personal digital assistant, responding to an e-mail sent from the retailer or through any other technique. Once the information is provided to complete the web page, the information may be delivered to the registration server for the generation of an e-mail registration notice that may be delivered to the manufacturer. Still other embodiments of the systems and methods described herein may be realized without departing from the scope of the invention.

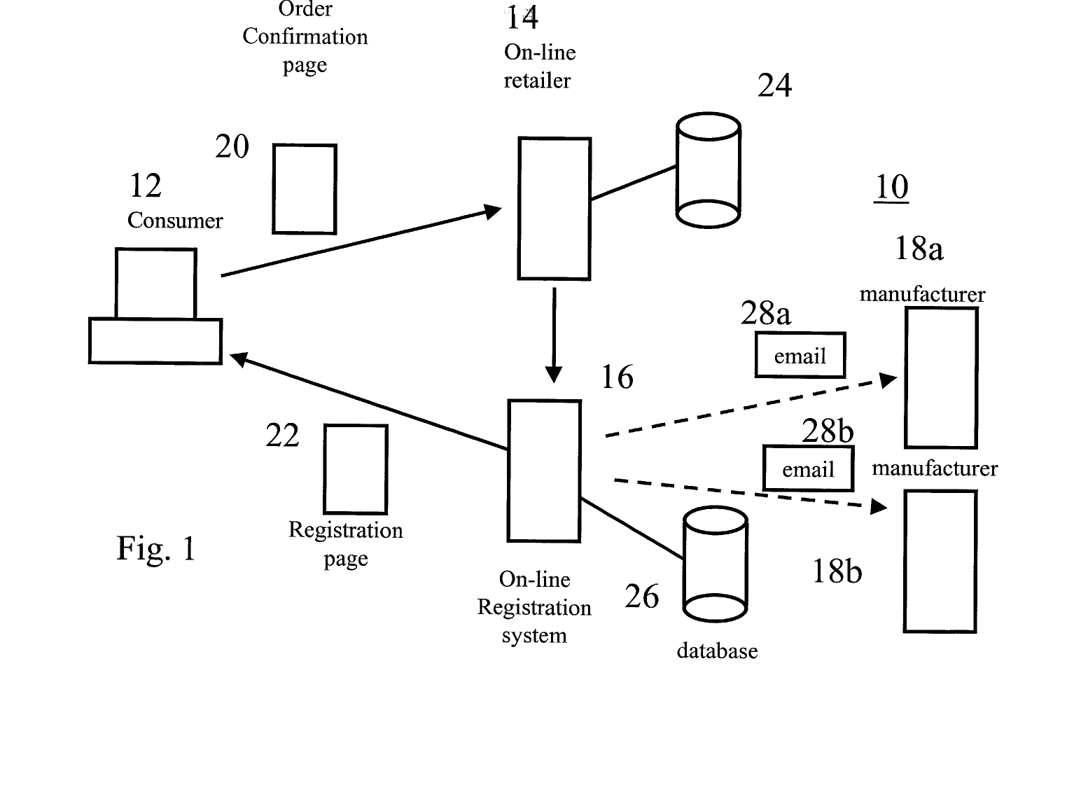

FIG. 1 presents a system 10 according to the invention wherein the system 10 and allows a consumer purchasing goods from an online retailer to register products during the purchase transaction, and accordingly depicts the system wherein an online retailer is capable of allowing a consumer to register a product during a purchasing transaction. More specifically, FIG. 1 depicts a system 10 wherein there is presented a consumer 12, an online retailer 14, an online registration system 16, a plurality of manufacturers, shown as 18A and 18B. FIG. 1 further depicts that the online retailer 14 and online registration system 16 may present to the consumer 12 information, shown in FIG. 1 as conventional Web pages 20 and 22, that allow the consumer to confirm an order to purchase goods and to register a product.

Additionally FIG. 1 depicts that the online registration system 16 may deliver e-mail registration notifications 28A and 28B to the manufacturers 18A and 18B, respectively. FIG. 1 further shows that the online registration system 16 may include a database 26 wherein consumer data collected during registration activities is aggregated for later use. A database 24 is also shown, and may optionally be included as part of the online retailer site 14.

As shown in FIG. 1, a consumer 12 may access an online retailer 14 for purchasing goods and products from that online retailer 14. During the purchasing transaction, the online retailer may presented to the consumer 12 and order confirmation page that the consumer can activate, typically by clicking a control on page designated as “accepted” or “submits”. Once activated the confirmation page indicates to the online retailer 14 that the consumer has completed the purchasing transaction. The online retailer 14 may designate this point as the completion point for the transaction and at that time may present to the consumer 12 a web page that queries the consumer 12 as to whether they wish to register any of the products they have just purchased. As shown in FIG. 1, in the illustrated practice, this is accomplished by having the online retailer 14 identify this point of completion. Once the point of completion has occurred, the retailer 14 may send a message to the online registration system 16 that consumer 12 wishes to register a purchased product. As shown in FIG. 1, the online registration system 16 receives the request from the online retailer 14 and presents the registration page 22 to the consumer 12, as will be described in more detail herein. The consumer 12 may interact with the online retailer 16 to register those products that have been purchased from the online retailer 14 and for which the online Registration system 16 provides registration services.

As further shown in FIG. 1, once the consumer 12 has provided the online registration system 16 with sufficient information to complete the registration process, the online Registration system 16 may generate e-mail registration notifications, such notifications being depicted in FIG. 1 as e-mail notifications 28A and 28B. The e-mail notifications are delivered to the respective manufacturers, 18A and 18B, and the products are deemed registered. Optionally, as again will be described below the manufacturers 18 A and 1 8B may acknowledge the registration of these products to the online registration system 16, that may, in turn, provide the consumer 12 with acknowledgment that the product registration process has been completed and accepted by the manufacturer.

For the depicted system 10, the consumer 12 may comprise a conventional client system that can be any suitable computer system such as a PC workstation, a handheld computing device, a wireless communication device, a network appliance or any other such device, equipped with a network client capable of accessing a network server and interacting with a server to exchange information with the server. For those alternative embodiments wherein the system is embedded within a retail device, such as a cash register, the data processing system 12 may be absent, or considered to be part of a micro-controller system embedded into the cash register that can access the registration server 16.

In the depicted embodiment, the client 12 is a web client, such as a web browser that can include the Netscape web browser, the Microsoft Internet explorer web browser, the Lynx web browser, or a proprietary web browser, or web client that allows the user to exchange data with a web server, and ftp server, a gopher server, or some other type of network server. Optionally, the client and the server rely on an unsecured communication path, such as the Internet, for accessing services on the remote server. To add security to such a communication path, the client and the server can employ a security system, such as any of the conventional security systems that have been developed to provide to the remote user a secured channel for transmitting data over the Internet. One such system is the Netscape secured socket layer (SSL) security mechanism that provides to a remote user a trusted path between a conventional web browser program and a web server. Therefore, optionally and preferably, the client system 12 and the on-line retailer server system 14 have built in 128 bit or 40 bit SSL capability and can establish an SSL communication channel between the clients 12 and the server 14. Other security systems can be employed, such as those described in Bruce Schneir, Applied Crytpography (Addison-Wesley 1996). Alternatively, the systems may employ, at least in part, secure communication paths for transferring information between the server and the client. For purpose of illustration however, the systems described herein, including the system 10 depicted in FIG. 1 will be understood to employ a public channel, such as an Internet connection through an ISP or any suitable connection, to connect the subscriber systems 12 and the server 14.

The on-line retailer 14, in the depicted embodiment, comprises a server 14 that may be supported by a commercially available server platform such as a Sun Sparc™ system running a version of the Unix operating system and running a server capable of connecting with, or exchanging data with, one of the subscriber systems 12. In the embodiment of FIG. 1, the server 14 includes a web server, such as the Apache web server or any suitable web server. The web server component of the server 14 acts to listen for requests from consumer systems 12, and in response to such a request, resolves the request to identify a filename, script, dynamically generated data that can be associated with that request and to return the identified data to the requesting consumer system 12. The operation of the web server component of server 14 can be understood more fully from Laurie et al., Apache The Definitive Guide, O'Reilly Press (1997). The server 14 may also include components that extend its operation to accomplish the retail transactions described herein, and the architecture of the server 14 may vary according to the application.

The server 14 may couple to a database 16 that stores information representative of a consumer's account, including information about the different products the consumer has purchased. The depicted database 16 may comprise any suitable database system, including the commercially available Microsoft Access database, and can be a local or distributed database system. The design and development of database systems suitable for use with the system 10, follow from principles known in the art, including those described in McGovern et al., A Guide To Sybase and SQL Server, Addison-Wesley (1993). The database 12 can be supported by any suitable persistent data memory, such as a hard disk drive, RAID system, tape drive system, floppy diskette, or any other suitable system. The system 10 depicted in FIG. 1 includes a database device that is separate from the server station platform 14, however, it will be understood by those of ordinary skill in the art that in other embodiments the database device 16 can be integrated into the server 14.

Turning again to FIG. 1, it may be seen that the online registration system 16 acts as a middleware device for products sold by an online retailer. To this end, the online registration system 16 includes a database 26 that stores information about the product registration information required for registering a product, warranty, or other incentive from a manufacturer. The online registration system 16 builds the database 16 by contacting different manufacturers, such as depicted manufacturers 18A and 18B. For example, the online registration system 16 may be operated as a service that will contact different manufacturers of consumer goods, for example Sony, Firestone, Evenflo, MacLeran, or any other manufacturer. By contacting these manufacturers, the online the registration service may develop a database 26 that includes a plurality of data records wherein each data record is associated with a product provided by a manufacturer. Each respective record may include a registration requirements list representative of the information that is to be collected from a consumer for registering that product with associated manufacturer. This information may be provided by any source. For example, for those online retail sites that collect information from a consumer, such as name, address, telephone number, another information useful for delivering products from the retailer to the consumer, the basic demographic information for completing the product registration process may be provided by the online retail site. Similarly, the online Registration system 16 may employ cookies or other state information management systems, for pre-populating a registration page that is to be presented to a consumer. Accordingly, it will be understood by those of ordinary skill in the art that any technique suitable for collecting information for completing the product registration process may be practiced with the systems and methods described around without departing from the scope thereof.

Table 1 presents one example of a data record of the type that may be stored within a database 26.

| | | |
|---|---|---|
| Product ID | Manufacturer ID | Req Info 1 |
| | | Req Info 2 |
| | | Req Info 3 |
| | | Req Info 4 |
| | | Req Info 5 |

As can be seen from table 1, the data record includes a product number, a manufacturer identification code, and a set of fields, which are representative of the information that is to be provided during the registration process. The database 26 may store a plurality of such records. However, it will be understood that any table structure, data model, or other arrangement of data may be employed by the system 10 for storing product registration information, without departing from the scope of the invention.

The data records stored at the online registration system site and may be accessed by the online retailer 14. In one practice, the online retailer 14 provides to a consumer 12 a page having a control that allows the consumer 12 to link to the online registration system 16. Upon activation of the online registration system 16 the online retailer 14 makes the request, such as a conventional hypertext transfer protocol request, to the Web server executing at the online registration system site 16. The request can include information that is representative of the product purchased by the consumer 12 at the online retailer site 14. This information may include the product identification codes (described in Table 1) employed by the online Registration system 16 for identifying products within its database 26. However, it will be understood that any suitable type of product identifier may be employed.

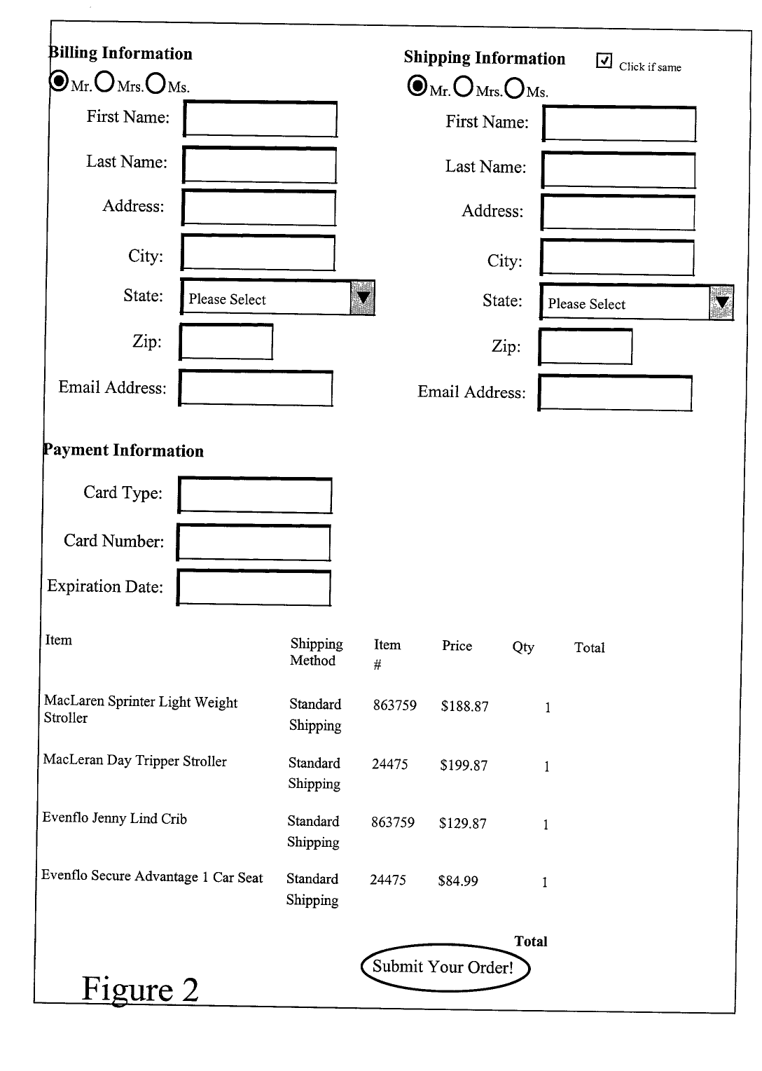

FIG. 2 depicts one example of a Web order confirmation page 20 that may be completed by a consumer 12 and delivered to the online retailer 14 during a purchas transaction. As shown in FIG. 2, a control “submit your order” is provided to the consumer 12. Upon activation of this control, the information present in the order confirmation page is delivered to the server of the online retailer 14. At this point the online retailer 14 identifies the transaction as completed. The online retailer 14 may then make a request to the online registration system 16. The request may comprise, as discussed above a conventional hypertext transfer protocol request, that directs the Web server of the online registration system 16 to deliver to the consumer 12 a web page that queries the consumer 12 as to whether or the consumer 12 wishes to register any of the products purchased on the online retailer site 14 which have been identified within the database 26 has been products which can be registered through the online registration system 16. In this operation, the WebServer for the online registration system 16 may receive with the request the product identification code's provided by the online retailer 14. In one practice, the product identification code are representative of uniform product identification codes provided by the manufacturer to identify the particular goods. The online Registration system 16 may cross reference the collected product identification codes against those product identification code's stored its database 26. In an optional alternative practice, the online registration system 16 may also directly query the manufacturers 18A or 18B to whether they have a registration data record for a product identified by the online retailer 14.

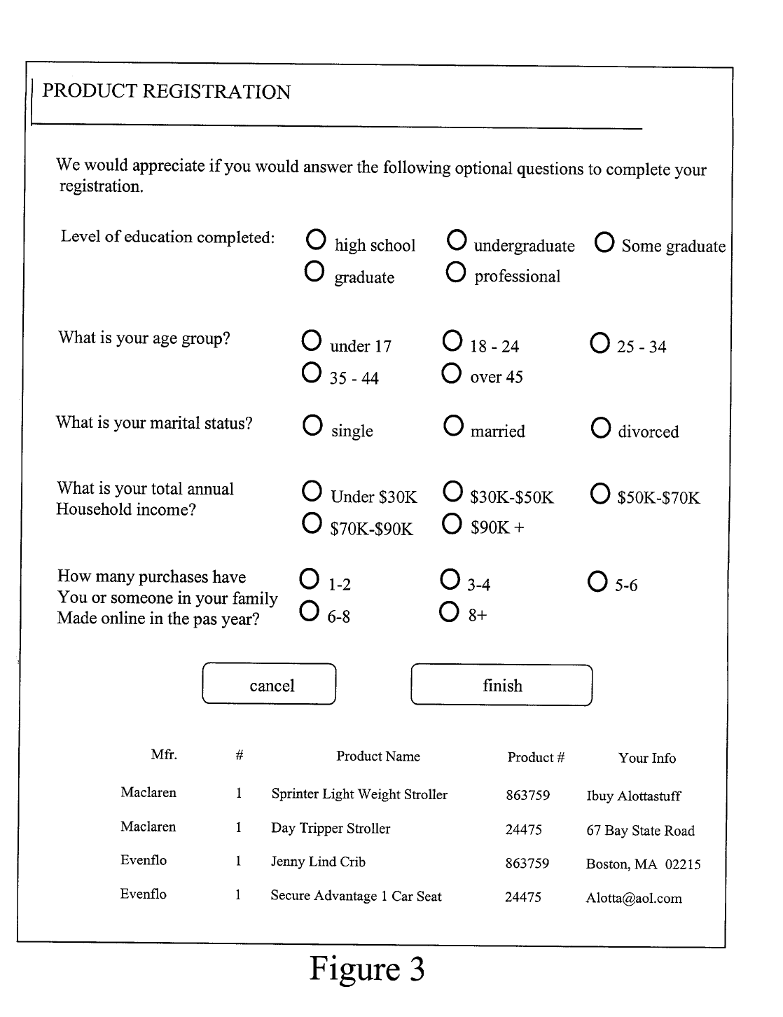

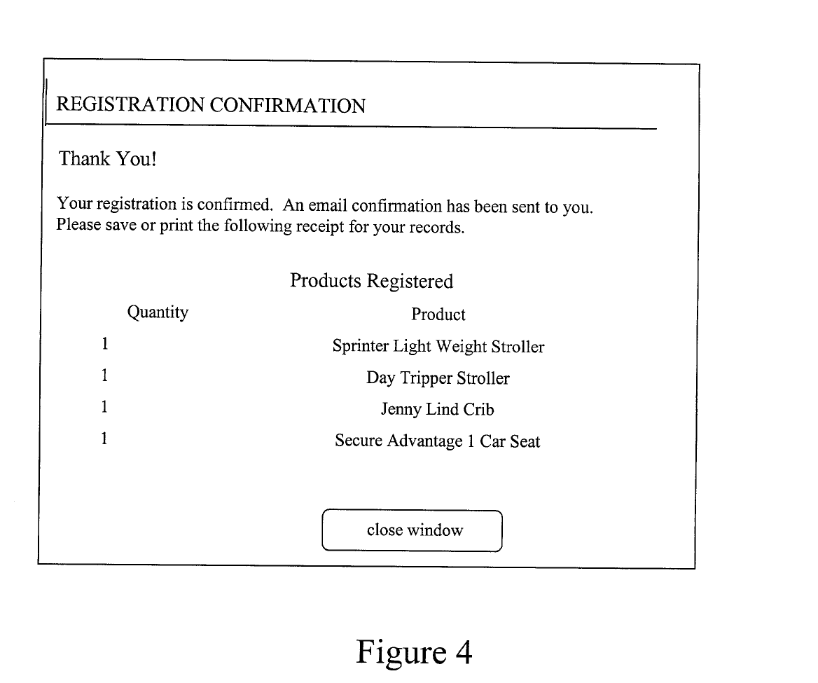

If the online registration system 16 determines that one or more products may be registered through its site, then the online registration system 16 may presents a query screen, such as the query screen depicted in FIG. 3 to the consumer 12. The query screen may query the consumer 12 as to whether they wish to register one or more of the purchased products. If the consumer 12 wishes to register a product, the consumer may activate the depicted “register” control. Upon activation of the control, the online registration system 16 may deliver to the consumer 12 a product registration page such as the depicted product registration page 22. One such product registration page is depicted in more detail in FIG. 4.

This registration page collects from the consumer information about the consumer including their level of education, age group, marital status, and other such demographic information. Once the information has been collected from the consumer 12, the consumer may activate the “finish” control. The information entered by the consumer 12 is then delivered to the online Registration system 16. The online registration system 16 may then generates the e-mail messages 28A and 28B each of which may be delivered to a respective manufacturer. The e-mail registration notification 28 may be received by the manufacturer 18 and the manufacturer 18 may register the purchased product. In an alternative embodiment, the online registration system 16 may generate a data record indicating that the consumer 12 as a register that particular product purchased from sites 14. The generated data record may later be delivered any patch process to the appropriate manufacturers. Still other techniques for notifying the respective manufacturers 18A and 18B that the product has been registered may be employed without departing from scope of the invention.

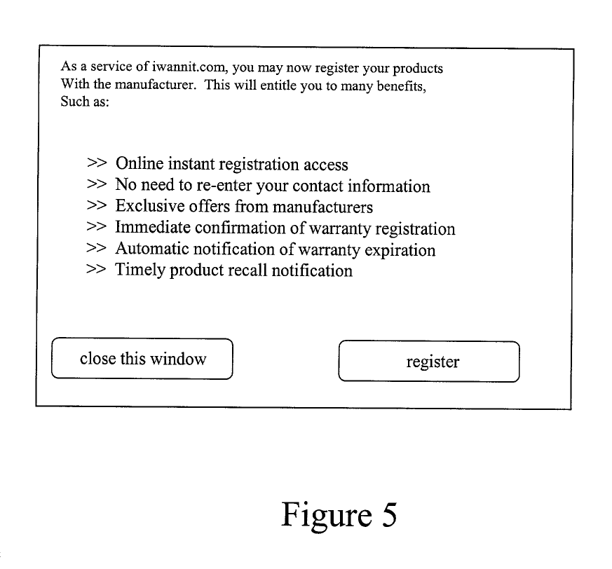

Once the registration has been completed, the online registration system 16 may generate a confirmation page for delivery to the consumer 12. One such confirmation page is depicted in FIG. 5. Once registration has been confirmed, the process terminates.

Described above the with reference to FIGS. 1 through 6 the online registration system 16 is supported by a service that the first creates an agreement with a manufacturer that the manufacturer will allow that service to register products produced by that manufacturer. However, the registration service may operate in other ways including first approaching retail sites and working with those retail sites to allow for the products sold on and site to be registered. Once a consumer registers products purchased at a site, the registration service then creates a database of products from different manufacturers that have been registered. The service may then approach the respective manufacturers and ask them whether they are interested in purchasing the registration information that has been collected for that manufacturer's products. In still other practices, the systems and methods described above may be proprietary and employed by a retail service for allowing consumers on that service to register products purchased from that site.

Alternatively, the systems and methods described herein may be provided as part of a suite of services that support consumer transactions. For example, customer support services that provide online user manuals, credit verification, and other such services may employ the systems and methods described here as part of that suite of services. Additionally, businesses that collect and analyze data relating to consumer behavior may also employ the systems and methods described here for collecting information about consumer purchases.

The systems and methods described above provide for the collection of valuable consumer data that may be employed for a plurality of reasons including marketing programs wherein specific types of consumers are targeted by particular manufacturers, and other such applications. For example, the online registration system 16 may develop the database 26 to include data about the purchases made by various consumers care in the information contained in this database is valuable for both people who purchased products as well as the businesses that sell products to consumers. To this end, the system 16 depicted above may include a process, such as a computer program executed on the server supporting the registration system 16, tell us a consumer to review the products that the consumer has registered. To this end, a buy file may be generated by the registration system 16 each time a new consumer registers a product. The buy file may be updated each time a consumer purchases additional products or services and registers those products or services.

In one practice upon receiving the confirmation of having registered a product, a consumer 12 may be provided with a password. With its password, the consumer may subsequently access the online registration system 16 directly. The consumer may then access their buy file by entering the password at that site. The buy file may contain information about the purchases the consumer has made and registered. For example, the buy file may include a list of all products purchased by that consumer, and the manufacturers that provide the product. Additionally the buy file may include information about the time and date of purchase, the site from which the product was purchased, the expiration date of any warranties provided with the products, contact information for reaching the manufacturer of the products, online manuals that show how the products work, information about resale information, such as a link to a site that indicates the present value of the product on a web auction site, and any other type of information that may be of interest to the consumer to see about the products they purchased. It is a realization of the invention, that the buy file acts as an asset management tool for allowing an individual or business to see the products they have purchased. Such an asset management tool is quite helpful for small businesses where the organization and inventorying of products and services is important for a number of reasons, including insurance purposes.

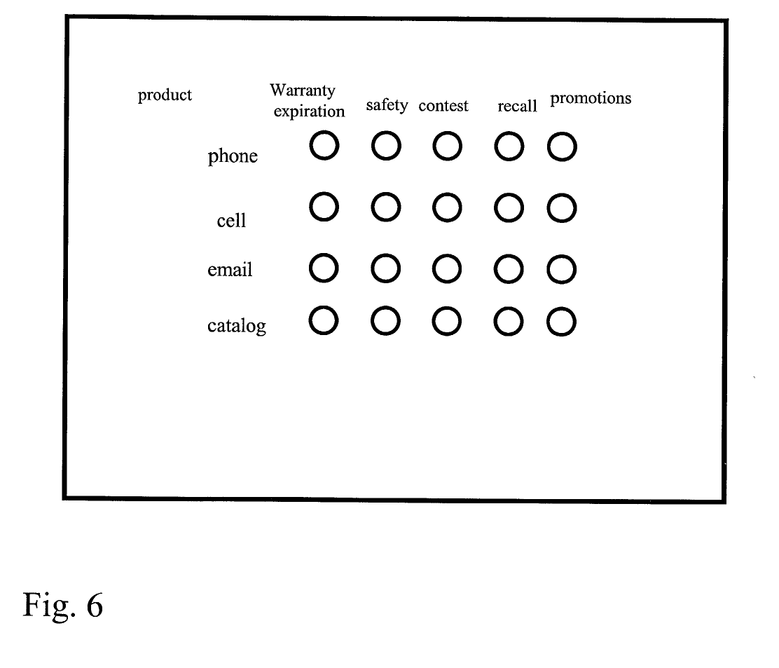

Additionally, in an optional embodiment each buy file may include information for each consumer or product purchased by that consumer that indicates the consumers willingness to receive information associated with that product. For example, FIG. 6 depicts one user interface that may be provided to consumer 12 for allowing the consumer to control, typically at the consumers option, to receive different types of notification and promotional literature for the different products purchased by that consumer. More specifically, FIG. 6 depicts a user interface 32 that is set up as an array of radio buttons 34 each of which may be a hypertext markup language control, or any other suitable type of control, that consumer 12 may activate. As can be seen from FIG. 6, the array of radio buttons 34 is provided for a particular product. Additionally, the array of radio buttons 34 allows the consumer to select for each type of possible event, such as the expiration of a warranty, a safety notification from a manufacturer, or government agency, a contest, a product recall, or a sales promotion, the type of solicitation the consumer will except. For example at a consumer's option, a consumer can choose not select any type of means for being solicited. Accordingly, the default of the radio buttons 34 is opt out the consumer 12 from receiving any solicitation. However at the consumer's option, the consumer may for example to receive warranty expiration information or notification by e-mail. A further example may be that the consumer will except recall notifications by telephone including by Mobil cellular telephone. Accordingly, the system 16 may allow a consumer to control how information is delivered to the consumer for particular product. The user interface 32 may be presented to the consumer 12 at the time of product registration, or alternatively at the time to consumer launched into the registration system 16 to view their buy file.

In the illustration of FIG. 6 each product is provided with an array of radio buttons 34. However in other practices, the consumer may be required to select a level of notification for all notification types for all products. Further optionally the consumer may be allowed to change the notification methods at any time. In a further practice, a manufacturer may be allowed to set a required level of notification for certain events. For example the Firestone tire company may require that any products purchased through a web site include a registration process wherein a user provides an e-mail address, and the user has to allow recall information to be delivered by e-mail to that consumer. Other mechanisms for controlling, modifying or adding to be control a notification information may be practice and the alternative practices will depend upon the particular application.

In one particular implementation, the online registration system 16 supports consumers access to the consumer data by providing a Web server platform that the consumer 12 may access. The WebServer may be conventional WebServer such as those developed with the cold fusion web site development tool from the Allaire Corp. of Cambridge MA. Data stored within the buy file's may be maintained within an Oracle database organized into a plurality of tables. The development of the tables, the data models, or the underlying schema made area according to the application in any suitable organization of tables may be employed for example tables may be organized to provide tables for each consumer, each manufacturer, each product, or any other way that suits the particular application. The development of such tables and databases is now to those of skill in the art in the use of such databases does not apart from the scope of the invention.

In a further embodiment, the registration system 16 may provide a database and WebServer mechanism that allows a manufacturer such as the illustrated manufacturers 18a and 18b, to query the database 26 of consumer information to develop a marketing program. For example, the registration system 16 may provide a database and server mechanism that allows a manufacturer to query the tables within the database to identify consumers having certain demographics. Optionally, and preferably, the manufacturer is given access to only certain nonconfidential, anonymous, or non-identity information within the database. Thus the manufacturer is prevented from accessing or viewing identity information such as names, addresses, and other such information. However, a manufacturer may be allowed to access information about geographic location of consumers, products purchased by consumers, online retail services used by consumers, and other such demographic information. The online retailer may develop a query to segment a database and identify that portion of consumers within the database 26 that meet certain demographic requirements. The manufacturer may request that the online registration system 16 conduct an e-mail marketing campaign that delivers an e-mail, typically developed by the manufacturer, to each of the targeted customers having the selected demographic qualities. In this way, the manufacturer 18a or 18b may conduct a targeted marketing campaign without getting identity information about the targeted customers. As discussed above, the e-mail marketing campaign may optionally include promotions, incentives, and other such information that can be delivered to consumer. For example, the marketing campaign may allow for delivering a coupon to the consumer. The coupon may require the consumer to return to the retail side where a product from the manufacturer was already purchased. At that site, the manufacturer may be willing to underwrite a 20 percent discount on a product from that manufacturer. As the manufacturer is providing coupons that drives traffic to the retailer site, the retailer may also be willing to underwrite the coupon for a selected portion. In this way, the manufacturer and retailer may conduct cooperative marketing campaigns.

As discussed above, the registration server 16 mechanism can be realized as software operating on a conventional data processing system such as a Unix workstation. In that embodiment, the registration server 16 mechanism can be implemented as a C language computer program, or a computer program written in any high level language including C++, Fortran, Java or basic. Additionally, in an embodiment where microcontrollers or DSPs are employed, the registration server 16 can be realized as a computer program written in microcode or written in a high level language and compiled down to microcode that can be executed on the platform employed. General techniques for high level programming are known, and set forth in, for example, Stephen G. Kochan, Programming in C, Hayden Publishing (1983).

Those skilled in the art will know or be able to ascertain using no more than routine experimentation, many equivalents to the embodiments and practices described herein. For example, it is a realization of the present invention that by providing a product registration system that is more facile, product registration may also be offered as a service provided with products in services that conventionally are not registered. Such products and services may include music compact discs, groceries, dry cleaning, restaurants, or any other type of good or service provided by a business that will benefit from a system that collects information about their customers. Accordingly, it will be understood that the invention is not to be limited to the embodiments disclosed herein, but is to be understood from the following claims, which are to be interpreted as broadly as allowed under the law.

I claim:

1. A method for product registration, comprising:
providing an on-line site for purchasing a product,
providing an on-line registration form for registering the purchased product,
identifying during the purchase transaction a completion point representative of when the purchase is complete, and
displaying the on-line registration form subsequent to the completion for allowing a user to register.

2. A method according to claim 1, wherein:
providing an on-line site includes providing an on-line site for purchasing products from a plurality of manufactures, and wherein,
providing an on-line registration form includes associating the on-line registration from with one of the plurality of manufacturers.

3. A method according to claim 1, further comprising:
aggregating product registration data for determining purchasing behavior of a user.

4. A method according to claim 1, further comprising:
employing product registration data for providing information associated with the product to a user.

5. A method according to claim 4, wherein the information associated with the product includes information about a product recall.

6. A method according to claim 4, wherein the information associated with the product includes information about warranty expiration.

7. A method according to claim 4, wherein the information associated with the product includes information about similar products.

8. A method according to claim 4, wherein the information associated with the product includes a survey form for collecting customer satisfaction information.

9. A method for allowing a retail site to provide on-line product registration, comprising
identifying products sold on the retail site that can be registered on-line,
providing for each product, a registration requirement list representative of information to be collected from a consumer for registering the product with an associated manufacturer,
tracking purchases made by a consumer on the retail site that can be registered on- line,
generating for the tracked purchases a product registration page capable of prompting the consumer to enter information identified in the registration requirement list for each tracked purchase, and
generating for each tracked purchase a product registration request having information capable of registering the product with the respective manufacturer.

10. A method according to claim 9, further comprising
employing the registration information for each tracked purchase to generate a database representative of purchase activity of a consumer.

11. A method according to claim 9, further comprising
allowing a manufacturer to employ the registration information for a product manufactured by that manufacturer to deliver an e-mail advertisement for a product to a consumer.

12. A method according to claim 11, wherein the e-mail advertisement includes a link to a retail site offering the product for sale.

13. A method according to claim 11, wherein the e-mail advertisement includes a purchase incentive wherein a portion of the incentive is underwritten by the retail site and a portion of the incentive is underwritten by the manufacturer.

14. A service for providing on-line retail sites with point-of-purchase product registration, comprising
providing each on-line retail site with a link to a server for supporting on-line product registration,
detecting activation of the link and delivering to the server information representative of products selected for registration,
for each selected product, identifying a registration requirement list representative of information to be provided for registering the product with an associated manufacturer,
generating a product registration page for prompting the consumer to enter information identified in each registration requirement list, and
generating for the selected products a registration request having information capable of registering selected products with respective associated manufacturers.
